(19) United States
(12) Patent Application Publication
(10) Pub. No.: US 2006/0103877 A1
(43) Pub. Date: May 18, 2006

(54) Image forming system having a scanned-image preview function and method thereof

(76) Inventors: Hee-ran Lee, Seoul (KR); Hyung-jong Kang, Seoul (KR)

Correspondence Address: STANZIONE & KIM, LLP, 919 18TH STREET, N.W., SUITE 440, WASHINGTON, DC, 20006, US

(21) Appl. No.: 11/280,264

(22) Filed: Nov. 17, 2005

(30) Foreign Application Priority Data
Nov. 18, 2004 (KR) 2004-94469

(51) Int. Cl. G06F 3/12

(52) U.S. Cl. 358/1.15

(57) ABSTRACT

An image forming system having a scanned-image preview function and a method thereof. The image forming system includes an image input device to scan one or more images, and a terminal device to receive image data of the one or more images scanned by the image input device and to sequentially display the one or more scanned images on a screen at a set time interval. Accordingly, the image forming system can sequentially display a plurality of images at a set time interval in a limited display space.

### CROSS-REFERENCE TO RELATED APPLICATIONS

This application claims the benefit under 35 U.S.C. § 119 of Korean Patent Application No. 2004-94469, filed on Nov. 18, 2004 in the Korean Intellectual Property Office, the entire content of which is incorporated herein by reference.

### BACKGROUND OF THE INVENTION

1. Field of the Invention

The present general inventive concept relates generally to an image forming system having a scanned-image preview function and a method thereof. More particularly, the present general inventive concept relates to an image forming system having a scanned-image preview function and a scanned-image preview method capable of sequentially displaying a plurality of images scanned by an image input device in a limited display space at a predetermined time interval.

2. Description of the Related Art

Recently, multi-function image input devices have become popular. The multi-function image input devices incorporate single-function image input devices, such as facsimile machines, scanners, printers, photocopiers, etc. When an image input device is used in connection with a terminal device, such as a personal computer (PC), the terminal device requires installation of a driver program (i.e., a printer driver, a scan driver, or the like) that is provided by a maker of the corresponding image input device in order to control functions that can be offered by the image input device.

A user can use a variety of functions that the image input device provides by executing the corresponding driver programs installed in the terminal device. For example, when a scan function of the image input device is used, the image input device converts scanned data read from a book, a document, or the like into data that a peripheral device can recognize to enable the scanned data to be displayed on a screen.

FIG. 1 illustrates a conventional scanned-image preview function display. As illustrated in FIG. 1, a user first executes the scanner driver, and sends a scan command to the image input device through the scanner driver in order to scan a plurality of images 13a, 13b, and 13c. The scanned images 13a, 13b, and 13 care sent to the terminal device by the image input device. The terminal device receives and displays the scanned images 13a, 13b, and 13c on the screen through a scanner user interface (UI) window 10. The scanner UI window 10 includes movement keys 15a and 15b to switch a current image displayed in the scanner UI window 10. The user clicks on any of the movement keys 15a and 15b with a mouse pointer 17 to display a previous or a next image 13b or 13c instead of the current image 13a displayed in the scanner UI window 10.

As described above, when the user sequentially displays the plurality of the scanned images 13a, 13b, and 13c on the scanner UI window 10, the user is required to click on one of the movement keys 15a or 15b with the mouse pointer 17 to switch among the scanned images 13a, 13b, and 13c. Therefore, the more scanned images to be displayed, the more times the user is required to click one of the movement keys 15a and 15b using the mouse pointer 17. In particular, when the user is searching for a specific scanned image, the user is required to search through all of the scanned images that appear before the specific scanned image until the user reaches the specific scanned image.

Additionally, the user typically scans an entire image, and then selects and stores a specific area of the scanned image 13a, 13b, or 13c to be displayed through the scanned UI window 10. Since the user scans the entire image including area that the user may not even be interested in, it takes more time for the user to scan the image. Thus, a large load is applied to scan resources of the image input unit.

### SUMMARY OF THE INVENTION

The present general inventive concept provides an image forming system having a scanned-image preview function and a method capable of sequentially displaying a plurality of scanned images at a predetermined time interval in a limited display space.

The present general inventive concept also provides an image forming system having a scan area selecting function to scan only a specific area of an image to be scanned and a method thereof.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an image forming system, comprising an image input device to scan one or more images, and a terminal device to receive image data of the one or more images scanned by the image input device and to sequentially display the one or more images on a screen at a predetermined time interval.

The terminal device may include a scan control section to select a scan area, a second memory section to store the image data of the one or more scanned images corresponding to the selected scan area, and a scan UI generation section to read the stored image data from the second memory section and to generate a scanner UI window to sequentially display the one or more images that correspond to the read image data at the predetermined time interval.

The scanner UI window may include an image window to display the one or more images, a scanner configuration window to enable a user to set at least one of a paper size and the scan area, and a preview window to enable the user to set at least one of the predetermined time interval, a rotation angle of an image, and an image enlargement.

The image input device may include a terminal device interface section to receive a scan area select command to select a specific scan area from the terminal device, a scan section to scan the one or more images based on the scan area select command, and a control section to control the scan section to scan the one or more images based on the scan area select command and to generate the corresponding image data accordingly.

The foregoing and/or other aspects of the present general inventive concept may also be achieved by providing an image forming system, comprising a scanner to scan one or more images, and a host device to receive raw data from the scanner and to automatically sequentially display the raw data on a display part thereof when a preview option is selected.

The foregoing and/or other aspects of the present general inventive concept may also be achieved by providing a method of previewing one or more images in an image forming system, the method comprising scanning the one or more images, temporarily storing image data that corresponds to the one or more scanned images, reading the image data and displaying the one or more scanned images on a screen at a predetermined time interval.

The scanning of the one or more images may include selecting a scan area, and scanning the one or more images based on the selected scan area.

Further, the reading of the image data and the displaying of the one or more scanned images on the screen at the predetermined time interval may include setting at least one of a time interval option to correspond to the predetermined time interval, an image rotation angle option, and an image enlargement option, and displaying the one or more images on the screen based on the at least one set option.

The foregoing and/or other aspects of the present general inventive concept may also be achieved by providing a method of previewing scanned images in an image forming system, the method comprising scanning one or more images, receiving raw data that corresponds to the scanned one or more images, and automatically sequentially displaying the raw data when a preview option is selected.

The foregoing and/or other aspects of the present general inventive concept may also be achieved by providing a terminal device, comprising a scan control section to select a scan area, a second memory section to store in a raw file format image data that corresponds to one or more scanned images that corresponds to the scan area, and a scan UI generation section to read the stored image data from the second memory section, to generate a scanner UI window, and to sequentially display the one or more scanned images that correspond to the read image data at a predetermined time interval in the scanning UI window.

The scanner UI window may include an image window to display the one or more scanned images, a scanner configuration window to set at least one of a paper size and the scan area, and a preview window to set at least one of a time interval option to correspond to the predetermined time interval, an image rotation angle option, and an image enlargement option.

The foregoing and/or other aspects of the present general inventive concept may also be achieved by providing a terminal device usable with a scanning apparatus of an image forming system, comprising a scan control unit to transmit a scan command to the scanning apparatus to scan an image, the scan command defining a scan area of the image in which data scanned from the image is saved and a non-scan area of the image in which data scanned from the image is discarded.

The foregoing and/or other aspects of the present general inventive concept may also be achieved by providing a terminal device usable with a scanning apparatus of an image forming system, comprising a temporary memory unit to receive raw data that corresponds to one or more images scanned by the scanning apparatus and to temporarily store the received raw data, and a user interface to display the raw data that corresponds to the one or more images according to one or more preset display options.

The foregoing and/or other aspects of the present general inventive concept may also be achieved by providing a method of previewing one or more images in a terminal device, the method comprising temporarily storing image data that corresponds to one or more scanned images, and reading the image data and displaying the one or more scanned images on a screen at a predetermined time interval.

The reading of the image data and the displaying of the one or more scanned images on the screen at the set time interval may include setting at least one of a time interval option to correspond to the predetermined time interval, an image rotation angle option, and an image enlargement option, and displaying the one or more scanned images on the screen based on the at least one set option.

The foregoing and/or other aspects of the present general inventive concept may also be achieved by providing a user interface of an image input device of an image forming system, the user interface comprising an image window to display data of one or more images scanned from a predetermined scan area of one or more papers.

The foregoing and/or other aspects of the present general inventive concept may also be achieved by providing a computer readable medium containing executable code to create a user interface of an image input device of an image forming system, the medium comprising a first executable code to create an image window to display data of one or more images scanned from a predetermined scan area of one or more papers.

### BRIEF DESCRIPTION OF THE DRAWINGS

The above aspects and features of the present general inventive concept will be more apparent by describing certain embodiments of the present invention with reference to the accompanying drawings, in which:

FIG. 1 illustrates a conventional scanned-image preview function display;

FIG. 2 is a block diagram illustrating an image forming system according to an embodiment of the present general inventive concept;

FIG. 3 and FIG. 4 illustrate different views of a scanner user interface (UI) window of the image forming system of FIG. 2; and

FIG. 5 is a flow chart illustrating a scanned-image preview method according to an embodiment of the present general inventive concept.

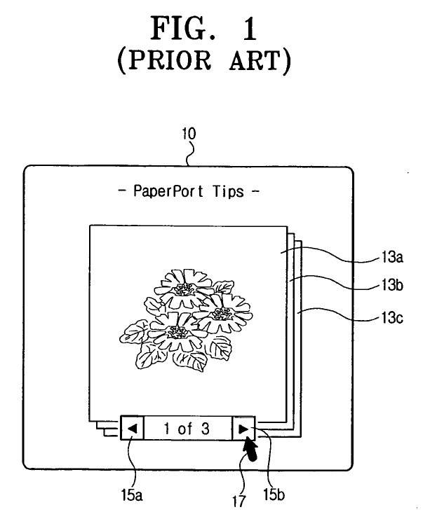

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

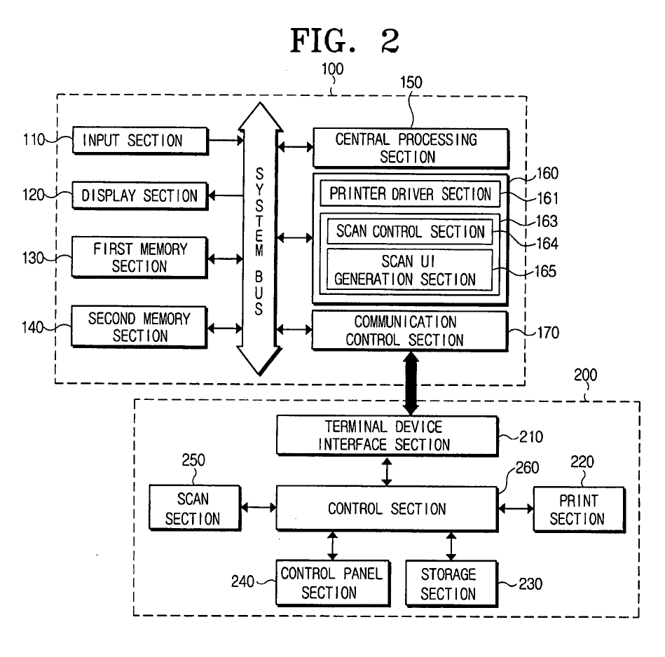

FIG. 2 is a block diagram illustrating an image forming system according to an embodiment of the present general inventive concept. As illustrated in FIG. 2, the image forming system includes a terminal device 100 and an image input device 200.

The terminal device 100 executes a scanner driver and a printer driver, and controls a scan operation and a print operation of the image input device 200. In particular, the terminal device 100 executes the scanner driver and sends a scan command to the image input device 200 to scan images. The terminal device 100 receives image data that corresponds to the scanned images from the image input device 200 and displays the scanned images on a screen, thus enabling a user to edit and/or store the scanned images. The image input device 200 scans the images based on the scan command sent from the terminal device 100, and sends the image data that corresponds to the scanned images to the terminal device 100.

A structure of the terminal device 100 is described below. The terminal device 100 includes an input section 110, a display section 120, a first memory section 130, a second memory section 140, a central processing section 150, a driver-executing section 160, and a communication control section 170.

The input section 110 may comprise a user interface. A user can set various functions supported by the terminal device 100 through the input section 110. The input section 110 may comprise a keyboard, a mouse, or the like, and the user may use the keyboard, mouse, or the like, to input various commands, relating to operation of the image forming system, to the terminal device 100. The various commands are sent along a system bus to the central processing section 150, which is described below.

The display section 120 may also comprise a user interface. The user can view information about various programs that can be executed on the terminal device 100 through the display section 120, which is capable of displaying text, graphics, etc. The display section 120 may be the cathode ray tube (CRT), a liquid crystal display (LCD), or the like, and the user can check a status and/or a result of the various programs that are being executed by looking at a UI window on the display section 120.

The first memory section 130 may be a non-volatile memory, such as a read only memory (ROM), such that content stored in the first memory section 130 remains unchanged even when the terminal device 100 is turned off. The first memory section 130 stores control programs and various application programs such as an operating system (OS) necessary to perform the functions of the terminal device 100. The first memory section 130 stores the scanner driver and the printer driver that control the image input device 200 to perform the scan operation and the print operation, respectively.

The second memory section 140 may be a volatile memory, such as random access memory (RAM), to store various data that is produced during execution of the programs such that the stored data can be removed upon necessity. The second memory section 140 temporarily stores the image data that corresponds to the images scanned by the image input device 200. The image data may be temporarily stored in raw file formats, such as bitmap files or temporary files. Once the images that correspond to the temporarily stored image data are previewed, the image data that corresponds to selected images is stored in files in a format selected by the user. In other words, the user can view the image data, which is in the raw file format, and determine which ones of the images and/or which parts of the images to save in the selected file format. Accordingly, only the image data that the user selects is saved in the selected file format.

The central processing section 150 executes a control program stored in the first memory section 130, and controls the operations of the terminal device 100. The central processing section 150 performs a variety of functions desired by the user through the application programs stored in the first memory 130, and stores the data that is produced during the execution of the application programs in the second memory section 140. The central processing section 150 controls the driver-executing section 160, which is described below, to execute the scanner and printer drivers to operate and control the image input device 200.

The driver-executing section 160 executes the scanner and printer drivers to control scanning, printing, etc., of the image input device 200, and includes a scanner driver section 163 and a printer driver section 161.

The printer driver section 161 executes the printer driver to control the print operations of the image input device 200. The printer driver may be provided with the image input device 200, and converts documents, files, or images created in the application programs into printer data that the image input device 200 can understand. The printer driver provides a print option setup window (now shown) in which the user can set print options to be applied to the documents that are to be printed.

The scanner driver section 163 executes the scanner driver to control scan operations of the image input device 200. The scanner driver section 163 includes a scan control section 164 and a scan UI generation section 165.

The scan control section 164 generates the scan control command. The scan control command may be based on one or more inputs or key operations received through the input section 110 of the terminal device 100. The one or more key operations may be input to the input section 110 by the user. That is, the scan control section 164 generates scan control commands to set a size of a document in which the images appear, an image scan area, etc., and provides the scan control commands to the image input device 200. When a plurality of images are scanned, the user can set a predetermined time interval for which the scanned images are sequentially displayed. The plurality of scanned images may be cycled through according to the set predetermined time interval to be displayed on the screen. In addition, the user can set a rotation option of the scanned images displayed on the screen, an image scaling option to scale the scanned images by a predetermined number of times, etc. Furthermore, the scan control section 164 temporarily stores the image data that corresponds to the scanned images in the second memory section 140 in the raw file formats, such as a bitmap file, a temporary file, or the like, and controls the scan UI generation section 165, which is described below, to display the stored image data on the screen according to the settings input by the user. The image data, in the raw filed format, may be displayed on the screen before converting the raw image data and saving the raw image data as a conventional image file format, such a PDF file format, a JPEG file format, or a GIF file format. The conventional file format in which to save the image data may be selected by the user. Thus, the user can view the scanned images or parts of the scanned images using the raw image data before deciding whether to save or edit the scanned images in one of the conventional image formats.

The scan UI generation section 165 generates a scanner UI window to display scanner driver option settings on the screen. The generated scanner UI window is displayed on the screen of the display section 120 so that the user can control the scan operations of the image input device 200 through the scanner UI window. That is, the user manipulates various function option buttons provided in the scanner UI window to generate the scan control commands. The scan UI generation section 165 displays the images that are scanned under the control of the scan control section 164 in the scanner UI window according to the predetermined time interval, the predetermined rotation angle, the image scaling, etc., as set by the user.

The communication control section 170 transfers data generated by the terminal device 100 to the image input device 200. More specifically, the communication control section 170 sends the data generated by the application programs and printer commands generated by the printer driver to the image input device 200. Furthermore, the communication control section 170 sends the scan control commands generated by the scan control section 164 to the image input device 200, and receives the image data that corresponds to the scanned images from the image input device 200 based on the scan control commands.

Hereinafter, a structure of the image input device 200 is described. The image input device 200 includes a terminal device interface section 210, a print section 220, a storage section 230, a control panel section 240, a scan section 250, and a control section 260.

The terminal device interface section 210 is connectable to the terminal device 100 and supports bidirectional communication with the terminal device 100. That is, the terminal device interface section 210 forwards various commands and data sent from the terminal device 100 to the control section 260 of the image input device 200, which is described below. The terminal device interface section 210 provides the terminal device 100 with the image data that corresponds to scanned images.

The print section 220 prints the image data received from the terminal device 100 onto sheets of paper under the control of the control section 260.

The storage section 230 stores control programs to control the image input device 200, fonts used to print, and the like, and provides a storage space used to perform data conversions during the printing operation.

The control panel section 240 includes a manipulation section (not shown) to generate a key-input signal such that the user can control the image input device 200 therefrom, and a liquid crystal display (LCD) section (not shown) to display a status of the image input device 200.

The scan section 250 scans the images based on the scan control command generated and sent from the terminal device 100 to produce the image data. The scan section 250 enables the user to use an automatic document feeder (ADF) function so that the scan section 250 can scan a plurality of sheets of paper at one time and produces the image data that corresponds to the images from the plurality of sheets of paper. The image data is then sent to the terminal device 100 through the terminal device interface section 210 to be stored or edited.

The control section 260 controls the print section 220 to print the data received from the terminal device 100 according to a print command. The control section 260 controls the scan section 250 to scan the images according to the scan control command received from the terminal device 100, and controls the terminal device interface section 210 to transfer the image data generated by the scan section 250 to the terminal device 100.

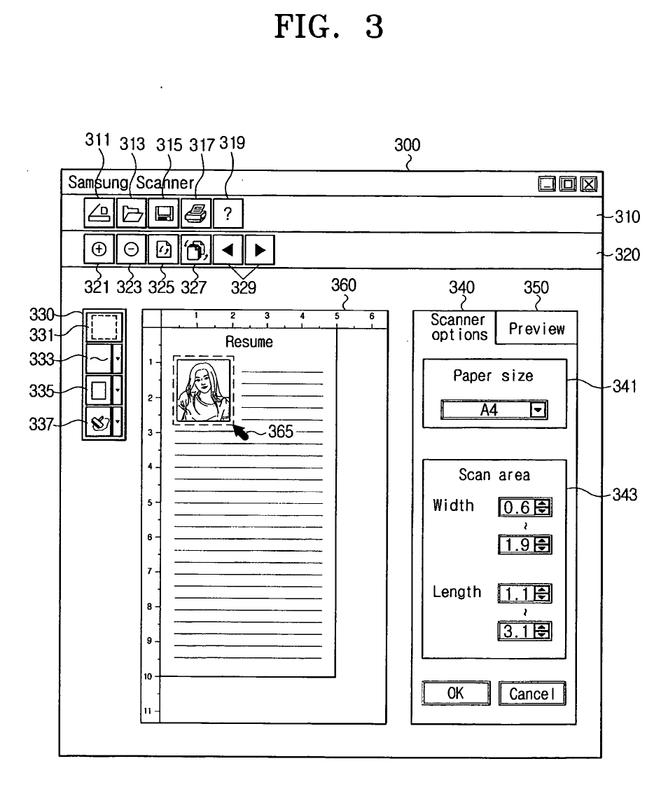

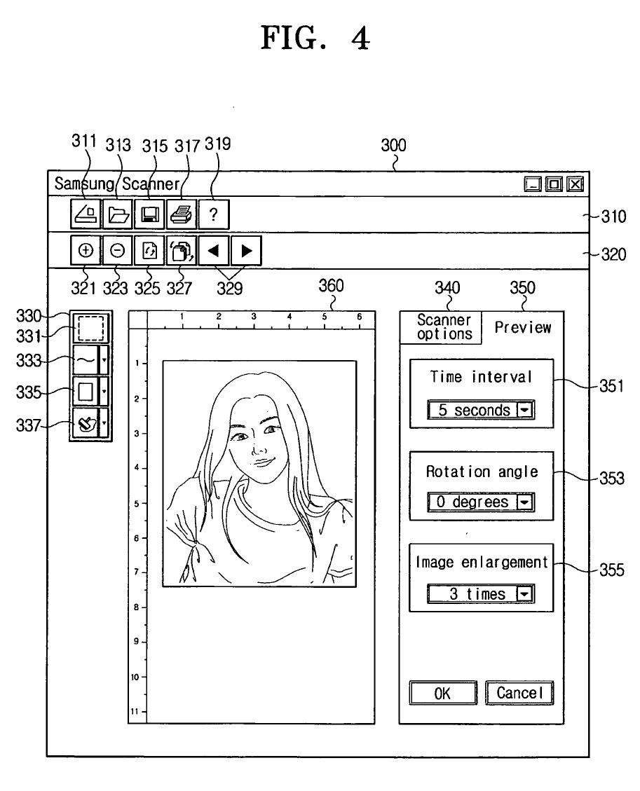

FIG. 3 and FIG. 4 are different views illustrating a scanner UI window 300 of the image forming system illustrated in FIG. 2. Referring to FIG. 3, the scanner UI window 300 includes a standard bar 310, a display bar 320, a drawing box 330, a scanner configuration window 340, a preview configuration window 350, and an image window 360.

The standard bar 310 includes a scan option 311, an open option 313, a store option 315, a print option 317, and a help option 319.

When a user selects (e.g., by clicking on) the scan option 311, the scan control command is generated and sent to the image input device 200. Accordingly, the image input device 200 scans images. When the user selects the open option 313 and selects specific image data from among the image data stored in the second memory section 140, the images that correspond to the specific image data are displayed in the image window 360. When the user selects the store option 315 and selects image data that corresponds to specific images from among a plurality of images received from the image input device 200, the selected image data is stored in the second memory section 140. When the user selects the print option 317, a print command is produced and sent to the image input device 200 to print image data that corresponds to the images displayed in the image window 360. When the user selects the help option 319, various help tips for the scanner driver are displayed in the scanner UI window 300.

The display bar 320 contains a zoom-in option 321, a zoom-out option 323, a rotate option 325, a slide show option 327, and a previous/next page option 329.

When the user selects the zoom-in option 321, an image that is displayed in the image window 360 is increased in size (i.e., enlarged) by the predetermined number of times. Conversely, when the user selects the zoom-out option 323, the image that is displayed in the image window 360 is decreased in size by the predetermined number of times. When the user selects the rotate option 325, the image that is displayed in the image window 360 is rotated by a predetermined rotation angle. When the user selects the slide show option 327, a plurality of images are sequentially displayed (i.e., cycled through) in the image window 360 at a predetermined time interval. When the user selects the previous/next page option 329, the image window 360 displays a next image or a previous image with respect to the image that is currently displayed in the image window 360.

The drawing box 330 includes a select tool 331, a line-drawing tool 333, a shape-drawing tool 335, and a color-selecting tool 337.

The select tool 331 selects a part of the image that is currently displayed in the image window 360, thereby enabling the user to delete or store the selected part of the image. The line-drawing tool 333 enables the user to draw various kinds of lines on the image that is currently displayed in the image window 360 and to edit the image. The shape-drawing tool 335 enables the user to draw various shapes on the image that is currently displayed in the image window 360 and to edit the image. The color-selecting tool 337 may be arranged together with the line-drawing tool 333 such that the user can select a color for a line and draw lines with the selected color. In addition, the color-selecting tool 337 may be arranged together with the shape-drawing tool 335 to draw a shape with the selected color.

The scanner configuration window 340 includes a paper size option window 341 and a scan area option window 343. The paper size option window 341 enables the user to set a size of paper having an image to be scanned. The user can set a scan area of the image to be scanned using the scan area option window 343. That is, when the user wants to scan a part of the image instead of the entire image, the user can set a width and a length of the image to be scanned and scan only the set scan area. The scan area setting can be used when the user scans a specific position of a plurality of sheets of paper on which the image(s) to be scanned appears.

There are two ways in which the scan area may be selected. First, the user can scan a sheet of a sample image, click on the select tool 331, drag and drop a mouse pointer 365 in the sample image to select a specific area of the sample image displayed in the image window 360 as the scan area. When the selected scan area is displayed in the scan area option window 343, the user can use the ADF function to scan the images from the scan area of a plurality of sheets of paper. Second, if the user knows a position and a size of the image or part of the image to be scanned, the user can set the width and the length of the image to be scanned in the scan area option window 343 and scan the plurality of sheets of paper using the ADF function. Thus, the scan area that corresponds to the set width and length is scanned in the plurality of sheets of paper.

FIG. 4 illustrates setting of a preview function in the scanner UI window 300.

A preview configuration window 350 includes a time interval option window 351, a rotation angle option window 353, and an enlargement image option window 355. The scanner UI window 300 can contain both the preview configuration window 350 and the scanner configuration window 340. For example, each of the configuration windows 350 and 340 may be made viewable by selecting one or more tabs.

The user sets the predetermined time interval to sequentially display the plurality of the scanned images in the image window 360 using the time interval option window 351. That is, the user sets the predetermined time interval using the time interval option window 351 and selects the slide show option 327 to sequentially display the plurality of the scanned images at the set predetermined time interval in the image window 360. Thus, when the predetermined time interval is previously set using the time interval option window 351, images from a subsequent scanning operation can be viewed by simply selecting the slide show option 327.

The user can use the rotation angle option window 353 to rotate and display a scanned original image by a predetermined rotation angle in the image window 360. The user selects the rotate option 325 to rotate the scanned image by the predetermined rotation angle such that the rotated image is displayed in the image window 360.

The user can enlarge the scanned original image by the predetermined number of times so that the enlarged image is displayed in the image window 360. That is, the scanned image is displayed in the image window 360 according to the predetermined number of times set in the enlargement image option window 355. When the user selects the zoom-in option 321 or the zoom-out option 323, the displayed image is enlarged or reduced by the predetermined number of times set in the enlargement image option window 355.

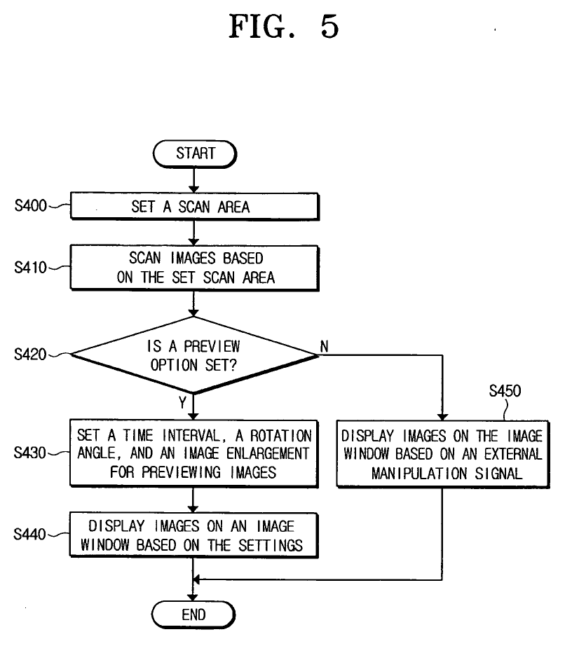

FIG. 5 is a flow chart illustrating a scan image preview method according to an embodiment of the present general inventive concept. The scan image preview method of FIG. 5 may be performed by the image forming system of FIG. 2. Thus, the scan image preview method of FIG. 5 is described below with reference to FIGS. 2 through 5.

Referring to FIG. 5, the user sets the scan area using the scanner UI window 300 (operation S400). In particular, the user may drag and drop the mouse pointer 365 to set the scan area. Alternatively, the user can set the scan area through the scan area select window 343.

One or more images are then scanned in the set scan area (operation S410). When the user sets the scan area and selects the scan option 311, the scan control section 164 generates the scan control command. The scan control command generated by the scan control section 164 is then sent to the image input device 200 through the communication control section 170. Accordingly, the image input device 200 produces image data that corresponds to the set scan area of the one or more images. The image input device 200 may use the ADF function to scan a plurality of sheets of paper at one time to produce a plurality of image data.

Once the scan operation is completed, the user determines whether to set the predetermined time interval, the predetermined rotation angle, the image enlargement, etc., using the preview configuration window 350 (operation S420).

The user sets the predetermined time interval to sequentially display a plurality of images that correspond to the plurality of image data in the image window 360 using the time interval option window 351. Additionally, the user sets the predetermined rotation angle by which the images displayed in the image window 360 are to be rotated using the rotation angle option window 353. The user also sets the predetermined number of times by which the image to be displayed is enlarged or reduced (i.e., an enlargement rate) in the image window 360 using the enlargement image option window 355 (operation S430). In some cases, the user need not set the options (e.g., the predetermined time interval, the predetermined rotation angle, and the image enlargement) in the preview configuration window 350 to display the image data of the images. For example, if the user sets a first set of options for a first one or more scanned images, the user may want to maintain the first set of options for a second one or more scanned images. In this case, image data of the second one or more scanned images can be automatically viewed according to the first set of options without the user re-setting the options in the preview configuration window 350. Accordingly, the image data can be automatically viewed.

As described above, the user sets the preview function and selects the slide show menu 327 using the mouse pointer 365. The scan control section 164 controls the scan UI generation section 165 to display the images scanned according to the set predetermined time interval, the predetermined rotation angle, the image enlargement, etc., in the image window 360 (operation S440).

When the user does not set the preview function, the scan control section 164 controls the scan UI generation section 165 to display the scanned images according to manipulation by the user at, for example, the control panel section 240 on the image input device 200 (operation S450).

The present general inventive concept may be embodied in a computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code to cause a number of computer systems connected via a network to effect distributed processing.

Accordingly, using the preview function the user can view a plurality of the scanned images with a single mouse click. Additionally, since image data from the plurality of images is raw data that is temporarily stored as, for example, bitmaps or temporary files, the user can view the image data and determine which image data to discard, modify, or save as image files. As a result, resources of a terminal or host device in which the image files are stored can be conserved, since the user may decide to save selected image data as image files. The selected image data may correspond to selected images and/or selected portions of the images.

As described above, the various embodiments of the present general inventive concept enable a user to view a scanned image using a preview function capable of displaying a plurality of scanned images on a limited display space at a predetermined time interval.

Furthermore, the various embodiments of the present general inventive concept enable a user to select a desired area of an image appearing on a sheet of paper to reduce an amount of time and resources used to scan a plurality of images.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming system, comprising:
an image input device to scan one or more images; and
a terminal device to receive image data of the one or more images scanned by the image input device and to sequentially display the one or more scanned images on a screen at a predetermined time interval.

2. The image forming system as claimed in claim 1, wherein the terminal device comprises:
a scan control section to select a scan area;
a second memory section to store the image data of the one or more scanned images that corresponds to the scan area; and
a scan UI generation section to read the image data from the second memory section and to generate a scanner user interface (UI) window to sequentially display the one or more images that correspond to the image data at the predetermined time interval.

3. The image forming system as claimed in claim 2, wherein the scanner UI window comprises:
an image window to display the one or more images;
a scanner configuration window to enable a user to set at least one of a paper size and the scan area; and
a preview window to enable the user to set at least one of the predetermined time interval, a rotation angle of an image, and an image enlargement.

4. The image forming system as claimed in claim 1, wherein the image input device comprises:
a terminal device interface section to receive a scan area select command to select a specified scan area from the terminal device;
a scan section to scan the one or more images based on the scan area select command; and
a control section to control the scan section to scan the one or more images based on the scan area select command and to generate the corresponding image data accordingly.

5. The image forming system as claimed in claim 1, wherein the image data comprises raw data and the raw data is displayed on the screen.

6. The image forming system as claimed in claim 1, wherein the terminal device sets a scan area to scan the one or more images from one or more papers having the scan area and a non-scan area such that only the scan area of the one or more papers is scanned.

7. The image forming system as claimed in claim 1, wherein the terminal device receives a first portion of the image data to discard the first portion of the image data received from the image input device and store a second portion of the image data as image files.

8. The image forming system as claimed in claim 1, wherein the terminal device generates a user interface in which a scan area set such that the image input device scans the one or more images in the scan area and discards any image data that is not within the scan area.

9. A method of previewing one or more images in an image forming system, the method comprising:
scanning the one or more images;
temporarily storing image data that corresponds to the one or more scanned images; and
reading the image data and sequentially displaying the one or more scanned images on a screen at a predetermined time interval.

10. The method as claimed in claim 9, wherein the scanning of the one or more images comprises:
selecting a scan area; and
scanning the one or more images based on the selected scan area.

11. The method as claimed in claim 9, wherein the reading of the image data and the displaying of the one or more scanned images on the screen at the predetermined time interval comprises:
setting at least one of a time interval option to correspond to the predetermined time interval, an image rotation angle option, and an image enlargement option; and
displaying the one or more images on the screen based on the at least one set option.

12. A terminal device of an image forming system, comprising:
a scan control section to select a scan area;
a second memory section to store in a raw file format image data that corresponds to one or more scanned images that corresponds to the scan area; and
a scan user interface (UI) generation section to read the stored image data from the second memory section, to generate a scanner UI window, and to sequentially display the one or more scanned images that correspond to the read image data at a predetermined time interval in the scanner UI window.

13. The terminal device as claimed in claim 12, wherein the scanner UI window comprises:
an image window to display the one or more scanned images;
a scanner configuration window to set at least one of a paper size and the scan area; and
a preview window to set at least one of a time interval option to correspond to the predetermined time interval, an image rotation angle option, and an image enlargement option.

14. A terminal device usable with a scanning apparatus of an image forming system, comprising:
a scan control unit to transmit a scan command to the scanning apparatus to scan an image, the scan command defining a scan area of the image in which data scanned from the image is saved and a non-scan area of the image in which data scanned from the image is discarded.

15. A terminal device usable with a scanning apparatus of an image forming system, comprising:
a temporary memory unit to receive raw data that corresponds to one or more images scanned by the scanning apparatus and to temporarily store the received raw data; and
a user interface to display the raw data that corresponds to the one or more images according to one or more preset display options.

16. A method of previewing one or more scanned images in a terminal device of an image forming system, the method comprising:
temporarily storing image data that corresponds to the one or more scanned images; and
reading the stored image data and displaying the one or more scanned images on a screen at a set time interval.

17. The method as claimed in claim 16, wherein the reading of the stored image data and the displaying of the one or more scanned images on the screen at the set time interval comprises:
setting at least one of a time interval option, an image rotation angle option, and an image enlargement option; and
displaying the one or more scanned images on the screen based on the at least one set option.

18. A user interface of an image input device of an image forming system, the user interface comprising:
an image window to display data of one or more images scanned from a predetermined scan area of one or more papers.

19. A computer readable medium containing executable code to create a user interface of an image input device of an image forming system, the medium comprising:
a first executable code to create an image window to display data of one or more images scanned from a predetermined scan area of one or more papers.
